(19) United States
(12) Patent Application Publication
(10) Pub. No.: US 2008/0165209 A1
(43) Pub. Date: Jul. 10, 2008

(54) INFORMATION PROCESSING APPARATUS, DISPLAY CONTROL METHOD AND PROGRAM

(75) Inventors: Hirohito KONDO, Kanagawa (JP); Akari Hoshi, Tokyo (JP); Satoshi Akagawa, Tokyo (JP); Tomohiro Tsuyuhara, Kanagawa (JP); Zhezhu Jin, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/953,321

(22) Filed: Dec. 10, 2007

(30) Foreign Application Priority Data
Jan. 5, 2007 (JP) P2007-000346

(51) Int. Cl. G09G 5/00

(52) U.S. Cl. 345/670; 345/619

(57) ABSTRACT

An information processing apparatus including recording section for recording information on a feed of an RSS format, converting section where a picture contained in each feed whose information is recorded in the recording means is converted into a picture having a predetermined size on a basis of the number of vertical pixels, and display controlling section for displaying, for each feed, a title and a main text by predetermined numbers of rows, and a picture obtained through conversion by the converting means at a predetermined position, when a predetermined operation is performed in a state where a list of feed titles is displayed.

### BACKGROUND OF THE INVENTION

1. Field of the Invention

The present invention relates to an information processing apparatus, a display control method and a program, and more particularly to an information processing apparatus adapted to be capable of displaying a list of feeds in a Resource Description Framework Site Summary (RSS) format such that easily viewed by a user, a display control method and a program.

2. Description of Related Art

Web sites distributing information on feeds in an RSS format are increasing recently. If a user registers a feed distributor, the user can view the Web site immediately after update by checking a feed which is distributed when contents uploaded on a Web site is updated.

Japanese Patent Application Publication No. JP 2006-268201 discloses technique of aggregating associated feeds such that the aggregated feeds are presented to a user as feeds regarding one topic.

### SUMMARY OF THE INVENTION

As the number of distributors to be registered increases, there arises an issue of how a number of distributed feeds are presented to users. For example, each feed distributed from the same distributor may contain one picture or a plurality of pictures. If one picture or a plurality of pictures themselves are displayed in a feed list or the like, it leads not only to an unpleasant display, bad but also to the display hard to be viewed by a user.

According to embodiments of the present invention, a list of feeds in the RSS format is displayed in a manner easy to be viewed by a user. The present invention is made in view of the above.

According to the present invention, there is provided an information processing apparatus including recording means for recording information on a feed of an RSS format, converting means where a picture contained in each feed whose information is recorded in the recording means is converted into a picture having a predetermined size on a basis of the number of vertical pixels, and display controlling means for displaying, for each feed, a title and a main text of the feed by predetermined numbers of rows, and displaying a picture obtained through conversion made by the converting means at a predetermined position, responsive to a predetermined operation performed while a list of feed titles is displayed.

The display control means may allow display of one picture obtained through conversion made by the converting means for each feed.

The converting means may convert one picture designated to be displayed at a top, out of pictures contained in each feed.

The converting means may reduce a size of an image contained in each feed having vertical pixels numbers larger than a predetermined number of pixels in a manner vertical pixel numbers become the predetermined number of pixels.

According to the present invention, there are provided a display control method and a program including steps of converting a picture contained in each feed whose information is recorded in recording means into a picture having a predetermined size on a basis of the number of vertical pixels, and displaying, for each feed, a title and a main text of the feed by predetermined numbers of rows and displaying a picture obtained through conversion at a predetermined position, when a predetermined operation is performed in a state that a list of feed titles is displayed.

According to the present invention, a picture contained in each feed whose information is recorded in the recording means is converted into a picture having a predetermined size on the basis of the number of vertical pixels. If a predetermined operation is performed while a list of feed titles is displayed, a title and a main text of a feed are displayed by predetermined numbers of rows for the feed and a picture obtained through conversion is displayed at a predetermined position.

### BRIEF DESCRIPTION OF THE DRAWINGS

FIG. 1 is a diagram showing an example of an information processing apparatus according to an embodiment of the present invention.

FIG. 2 is a diagram showing an example of a list of RSS feeds.

FIG. 3 is a diagram showing another example of a list of RSS feeds.

FIG. 4 is a block diagram showing an example of the hardware structure of the information processing apparatus.

FIG. 5 is a block diagram showing an example of the functional structure of the information processing apparatus.

FIG. 6 is a flow chart illustrating a display switching process of the information processing apparatus.

FIG. 7 is a diagram showing another example of the information processing apparatus.

### DETAILED DESCRIPTION OF THE EMBODIMENTS

In the following description of the embodiments of the present invention, the correspondence relation between the constituent elements of the present invention and the embodiments described in the specification and drawings is as follows. The description is used for confirming that the embodiments supporting the inventions are described in this specification or drawings. Therefore, even if there is an embodiment not described as the embodiment corresponding to the constituent elements of the present invention, but described in the specification or drawings, it does not mean that this embodiment does not correspond to the constituent elements. Conversely, even if there is an embodiment described as one corresponding to the present invention, this does not mean that this embodiment does not correspond to those other than the constituent elements.

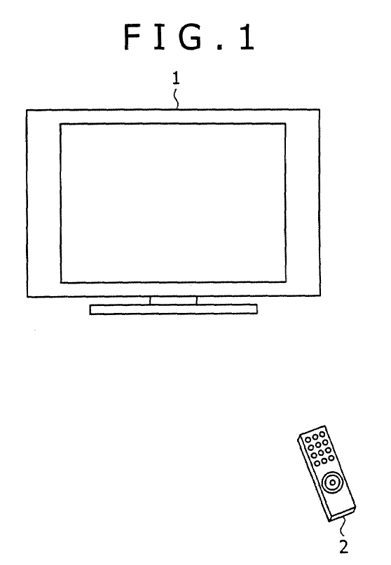

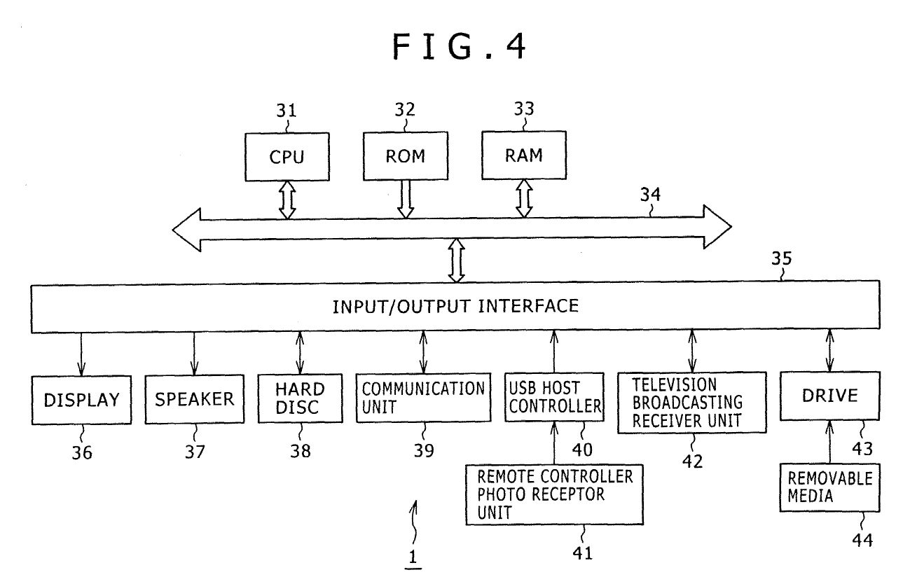

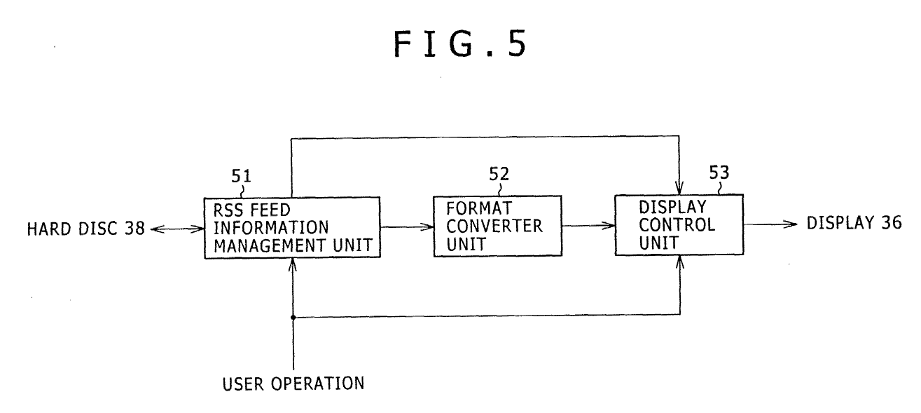

An information processing apparatus (e.g., an information processing apparatus 1 shown in FIG. 1) according to embodiments of the present invention includes recording means (e.g., a hard disc 38 shown in FIG. 4) for recording information on a feed of RSS format, converting means (e.g., a format converter unit 52 shown in FIG. 5) where a picture contained in each feed whose information is recorded in the recording means is converted into a picture having a predetermined size on a basis of the number of vertical pixels, and display controlling means (e.g., a display control unit 53 shown in FIG. 5) where a title and a main text of a feed are displayed by predetermined numbers of rows for each feed and a picture obtained through conversion made by the converting means is displayed at a predetermined position when a predetermined operation is performed while a list of feed title is displayed.

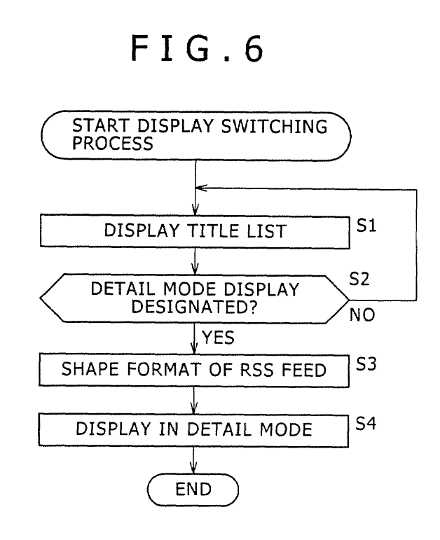

A display control method and program according to embodiments of the present invention includes steps (e.g., Step S4 shown in FIG. 6) of converting a picture contained in each feed whose information is recorded in recording means into a picture having a predetermined size on a basis of the number of vertical pixels and displaying, for each feed, a title and a main text of a feed by predetermined numbers of rows, and displaying a picture obtained through conversion at a predetermined position, when a predetermined operation is performed while a list of feed titles is displayed.

Embodiments of the present invention will be described with reference to the accompanying drawings.

FIG. 1 is a diagram showing an example of an information processing apparatus 1 according to an embodiment of the present invention.

As shown in FIG. 1, the information processing apparatus 1 is a television receiver. The information processing apparatus 1 mounts an operating system (OS), such as Windows (registered trademark) and Vista (trademark), and also functions as a personal computer.

The information processing apparatus 1 is connected to a network, and has a function of receiving information on feeds in the RSS formation distributed from a newspaper site and various portal sites registered in advance by a user, and in accordance with the received information, displaying a summary of original information such as news and comments to be uploaded on each Web site. Namely, the information processing apparatus 1 mounts an RSS reader for reading information on feeds in the RSS format. In the following, a feed in the RSS format is called an RSS feed where appropriate.

RSS is a data format to be used for writing titles (index), hyperlinks, pictures, texts and the like in the extensible Markup Language (XML) to show the summary of original information to be uploaded on Web site. An apparatus which receives distributed RSS feeds accesses a distributing site registered by a user at a predetermined time interval, and presents, to a user, an RSS feed to be obtained when a content of original information is updated, to allow a user to confirm the summary of updated original information. If it is instructed to display not only the summary but also the updated original information, the apparatus accesses a Uniform Resource Locator (URL) contained in the RSS feed as a link destination, to display original information (at the Web site).

A RSS feed acquired from the distributing site is sequentially stored on a hard disc or the like of the information processing apparatus 1. When a user performs a predetermined operation by using a remote controller 2, a list of RSS feeds is displayed on the display of the information processing apparatus 1, in accordance with the information stored on the hard disc.

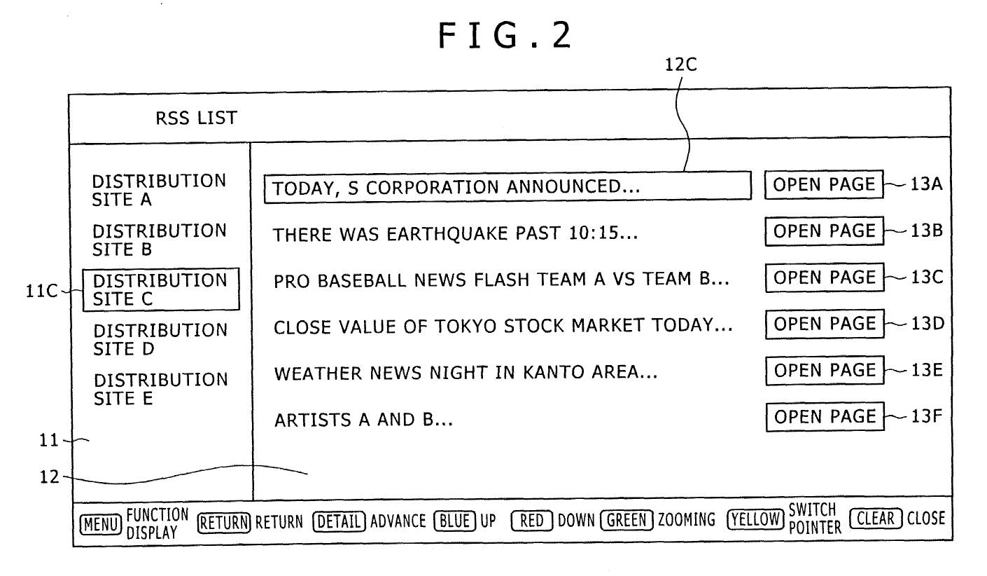

FIG. 2 is a diagram showing examples of a list of RSS feeds.

As shown in FIG. 2, a screen on which a list of RSS feeds is displayed is mainly constituted of a distributing site list display area 11 and a RSS feed display area 12. Under the distributing site list display area 11 and the RSS feed display area 12, functions assigned to buttons of the remoter controller 2 are explained.

In the example shown in FIG. 2, a “menu” button of the remote controller 2 is operated to display a list of functions, a “return” button is operated to return to a preceding screen, and a “detail” button is operated to display an RSS feed. A “blue” button of the remote controller 2 is operated to scroll upward, a “red” button is operated to scroll downward, a “green” button is operated to enlarge/reduce a display, and a “yellow” button is operated to change the position of a cursor (pointer). A “clear” button is operated to close a display of the RSS feed list.

The distributor site list display area 11 is a display column for displaying name list of RSS feed distributing sites. In the example of FIG. 2, the names of five distributor sites, distributor sites A to E, are displayed. In this example, the distributor site C is selected by the cursor 11C out of the distributor sites A to E. A user can select another distributor site by moving the cursor 11C by performing a predetermined operation with the remote controller 2.

The RSS feed display area 12 is a column for displaying some of titles, or the whole title if possible, of RSS feeds distributed from the distributor site selected by the cursor 11C in the distributor site list display area 11. A display of the RSS feed display area 12 is changed each time a distributor site selected by the cursor 11C is changed.

In the example shown in FIG. 2, as some of titles of the RSS feeds distributed from the distributor site C selected by the cursor 11C, followings are displayed sequentially from the top; “Today, S Corporation announced . . . ”, “There was earthquake past 10: . . . ”, “Professional Baseball News Flash, Team A vs Team B”, “Close value of Tokyo Stock Market today . . . ”, “Weather News, Night in Kanto area . . . ”, and “Artists A and B . . . ”.

The user can view a RSS feed by moving a cursor 12C presently selecting the title “Today, S Corporation announced . . . ” to a desired title and performing operations such as pressing the “detail” button of the remote controller 2.

For example, if there is a command to view the RSS feed in the state shown in FIG. 2, the whole title and the whole text of the RSS feed having title of “Today, S Corporation announced . . . ” are displayed in the RSS feed display area 12 in place of the title list shown in FIG. 2. If the RSS feed contains a picture, this picture is also displayed. Information on the RSS feed contains information designating the file storing image data and the display position of the picture to be displayed respectively as the RSS feed. In accordance with this designation, the picture is displayed at predetermined position.

Buttons 13A to 13F are displayed on the right side of the titles displayed in the RSS feed display area 12. Each of the buttons 13A to 13F is operated to access a Web site in accordance with URL contained as a link destination in the RSS feed, and to display original information whose summary is shown in the RSS feed. In order to display original information, the user moves the cursor 12C on any one of the buttons 13A to 13F by operating the remote controller 2, and performs a predetermined operation for determining an article.

For example, when the button 13A is operated, a Web site is accessed which presents the original information whose summary is presented by the RSS feed set with the title of “Today, S Corporation announced . . . ”, and the screen of the Web site is displayed in the RSS feed display area 12.

The information processing apparatus 1 is provided with a simple mode as shown in FIG. 2 and a detail mode, as the display mode for a list of RSS feeds. The user can confirm only a portion of the title of an RSS feed from the list displayed in the simple mode, but from a list of RSS feeds displayed in the detail mode, the user can confirm a picture and a text, not whole of RSS feeds though. Switching between the display modes is performed by pressing a predetermined button of the remote controller 2.

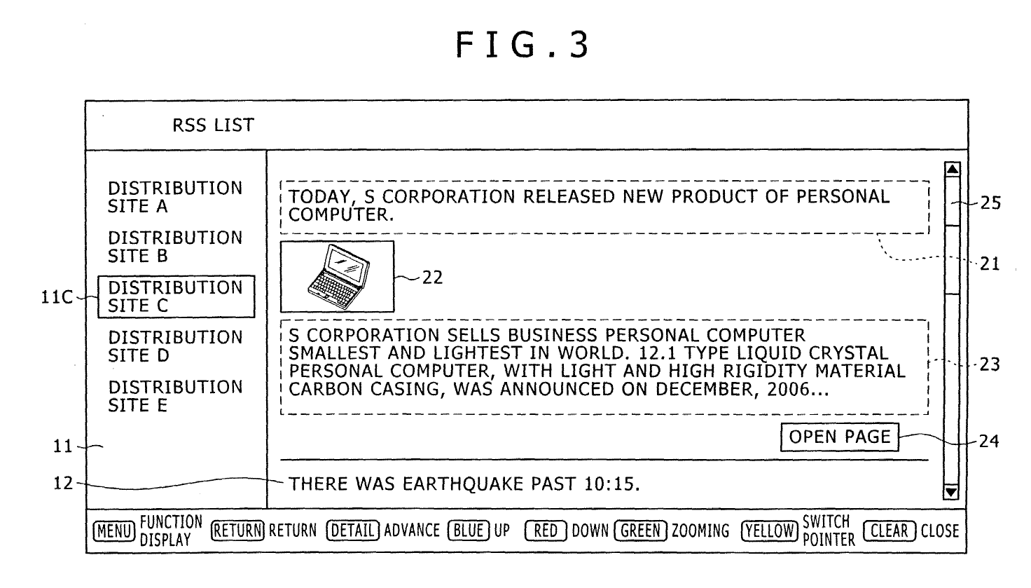

FIG. 3 is a diagram showing an example of a list of RSS feeds displayed in place of the screen shown in FIG. 2, when the detail mode display is designated.

In the example shown in FIG. 3, a title “Today, S Corporation announced new product of personal computer.” of the RSS feed selected with the cursor 12C in the list in the simple mode shown in FIG. 2 is displayed in an area 21, and in an area 22 under the title, a picture is displayed. In an area 23 under the area 22, a main text of the RSS feed is displayed, and a button 24 is displayed under the main text.

As described above, in the list of RSS feeds displayed in the detail mode, not only the title of each RSS feed but also a picture and a main text are displayed. In FIG. 3, dot lines indicating the areas 21 and 23 are not displayed actually, but are displayed for the purposes of description convenience.

As shown in FIG. 3, the title of the RSS feed is displayed by two lines in the area 21, and the main text is displayed by four lines in the area 23. If the title of the RSS feed exceeds two lines, end part of the title is substituted with “ . . . ”, and if the main text S exceeds four lines, “ . . . ” is substituted for end part.

The area 22 has a predetermined size, such as 420×320 pixels (horizontal, vertical). If the number of vertical pixels of a picture contained in the RSS feed is larger than 320, a size of the picture is reduced such that the vertical pixels become not larger than 320 on the basis of current vertical pixel numbers, and the thus reduced picture is displayed in the area 22.

For example, if an RSS feed contains a plurality of pictures, only one picture designated to be displayed at the top when the RSS feed is displayed is displayed after scaled down (when necessary) in the area 22. As described earlier, the RSS feed information contains information designating a display position of a picture, and in accordance with this information, one picture to be displayed on the top is selected. A picture having vertical pixels numbers not in excess of 320 pixels may be displayed without reducing the size.

In the list of RSS feeds displayed in the detail mode, the title of displayed by two lines, and below the title, one image to be displayed at the top in the RSS feed is displayed in a predetermined size. The main text is displayed under the picture by four lines, and below the main text, a button operated at a display of the original information is displayed.

As described above, the title is displayed by a predetermined number of rows, one picture having a predetermined size is displayed under the title, and the main text is displayed by a predetermined number of rows under the picture. Each RSS feed is displayed after formats are adjusted, thus it is possible to display a list of RSS feeds to allow easy view for a user.

This advantage becomes distinct particularly when the remote controller 2 is used which is more difficult to perform free operation than a mouse or the like. For example, if a list of RSS feeds is viewed by using a mouse, free operation using the mouse can deal with each feed regardless of display state of each feed. If the remote controller 2 is used, it may be difficult to deal with each feed in such a case.

In the example shown in FIG. 3, a scroll bar 25 is displayed at the right end of the RSS feed display area 12. A user can scroll a display area of the RSS feed list upward and downward by pressing the blue and red buttons mounted on the remote controller 2.

In the example shown in FIG. 3, under the information on the RSS feed having the title of “Today, S Corporation announced . . . ”, the title of “There was earthquake after 10:15.” is displayed with one straight line being inserted therebetween. In this manner, piece of information on each RSS feed is displayed sequentially along a vertical direction. A portion of the title of “There was earthquake after 10:15.” was displayed under the title of “Today, S Corporation announced . . . ” at a list in the simple mode.

As described above, for example, the RSS feed display area 12 is set in such a manner that when each RSS feed is displayed by aligning the title at the upper position of the RSS feed display area 12, the first row of the RSS feed one row below in the title list is displayed.

With reference to the flow chart, description will be later given on the processes to be executed by the information processing apparatus 1 to display a list of RSS feeds.

FIG. 4 is a block diagram showing an example of the hardware structure of the information processing apparatus 1.

A Central Processing Unit (CPU) 31 executes various processes in accordance with a program stored in a Read Only Memory (ROM) 32 or a program loaded from a hard disc 38 into a Random Access Memory (RAM) 33. RAM 33 stores also data or the like necessary for CPU 31 to execute various processes, when necessary.

CPU 31, ROM 32 and RAM 33 are interconnected via a bus 34. An input/output interface 35 is also connected to the bus 34.

Connected to the input/output interface 35 are a display 36 such as an Liquid Crystal Display (LCD), a speaker 37, the hard disc 38, and a communication unit 39 for making communications via a network. The communication unit 39 accesses a distributor server via the Internet and receives RSS feed information. The RSS feed information received by the communication unit 39 is supplied to and recorded in the hard disc 38 via the input/output interface 35. In accordance with the RSS feed information recorded in the hard disc 38, a list of RSS feeds shown in FIGS. 2 and 3 is displayed.

Also connected to the input/output interface 35 are a USB host controller 40, a television broadcasting receiver unit 42 and a drive 43. The USB host controller 40 accepts a signal from the remote controller 2 received at the remote controller photoreceptor unit 41 connected as a USB device.

The television broadcasting receiver unit 42 receives a signal from an antenna (not shown) which receives television broadcasting waves to acquire data of television programs broadcasted at certain channels. The data of the television program acquired by the television broadcasting receiver unit 42 is supplied to the display 36 via the input/output interface 35 to display the program, or to the hard disc 38 to be recorded therein.

A removal media 44 of optical discs, such as Blu-ray Disc (trademark) and Digital Versatile Disc (DVD) is mounted on the drive 43. A computer program read from the removal media 44 by the drive 43 is installed in the hard disc 38 when necessary.

FIG. 5 is a block diagram showing an example of the functional structure of the information processing apparatus 1. At least some of the functional units shown in FIG. 5 are realized by causing CPU 31 shown in FIG. 4 to execute a predetermined program.

As shown in FIG. 5, in the information processing apparatus 1, realizes an RSS feed information management unit 51, a format converter unit 52 and a display control unit 53. Information on user operation accepted at the USB host controller 40 is inputted to the RSS feed information management unit 51 and display control unit 53 in response to a signal from the remote controller 2.

The RSS feed information management unit 51 manages RSS feed information recorded in the hard disc 38. The RSS feed information contains a tag “<item>” indicating a start position and a tag “</item>” indicating an end position. A range sandwiched by these tags is judged as one RSS feed.

In addition, the RSS feed information includes tags representing a title, a picture, a main text, and a link destination URL. An area sandwiched by the tags “<title>” and “</title>” representing the title is judged as the title of the RSS feed. A file designated by the tags “<image>” and “</image>” representing the picture is judged as the picture. The picture is also added with information designating a display position. An area sandwiched by the tags “<description>” and “</description>” representing the main text is judged as the main text of the RSS feed, and an area sandwiched by the tags “<link>” and “</link>” representing the link destination URL is judged as an access destination URL for displaying original information.

For example, when a user designates to display a list of RSS feeds in the simple mode, the RSS feed information management unit 51 reads RSS feed information from the hard disc 38, and outputs title information on each RSS feed contained in the read out RSS feed information, to the display control unit 53.

For example, when it is designated to display certain RSS feed from the list of RSS feeds displayed in the simple mode, the RSS feed information management unit 51 outputs the information on the RSS feed designated to display, to the display control unit 53.

When the user designates to display the list of RSS feeds in the detail mode while the list of RSS feeds is displayed in the simple mode, the RSS feed information management unit 51 outputs information on the RSS feeds to be displayed on the RSS feed display unit 12, to the format converter unit 52.

In accordance with the information supplied from the RSS feed information management unit 51, the format converter unit 52 adjusts the formats of the RSS feeds, and outputs the information on the adjusted RSS feeds, to the display control unit 53. For example, the format converter unit 52 generates information to be used for displaying a title of a predetermined number or rows, a picture of a predetermined size, and a main text of a predetermined number of rows, respectively of each RSS feed, by converting information supplied from the RSS feed information management unit 51.

As described earlier, the format converter unit 52 reduces a size of a picture having vertical pixels larger than 320 pixels which is prepared for displaying at the top of the RSS feed, to a picture having 320 vertical pixels or less. The horizontal direction of the picture may be reduced at the same ratio as that used for reducing vertical pixels, or may be displayed as it is without reduction in pixel numbers.

The display control unit 53 displays the title supplied from the RSS feed information management unit 51, and a list in the simple mode such as shown in FIG. 2 is displayed. Information on the name of a distributor site or the like are supplied from the RSS feed information management unit 51 when necessary. The display control unit 53 moves a display position of the cursor in response to operation by a user, and for example, when it is designated to display certain RSS feed, the title, picture and main text of the RSS feed are displayed in accordance with the information supplied from the RSS feed information management unit 51.

When it is designated to display a list of RSS feeds in the detail mode, the display control unit 53 displays the title of a predetermined number of rows, a picture of a predetermined size, and a main text of a predetermined number of rows of each RSS feed, as shown in FIG. 3, in accordance with the information supplied from the format converter unit 52.

Next, with reference to the flow chart shown in FIG. 6, description will be made on a process of switching a display of a list of RSS feeds.

This process starts, for example, when the remote controller 2 is operated and it is designated to display a list of RSS feeds. When it is designated to display a list of RSS feeds, the RSS feed information management unit 51 supplies information on the title of each RSS feed contained in the RSS feed information, to the display control unit 53.

At Step S1 the display control unit 53 displays the title supplied from the RSS feed information management unit 51 and the list of RSS feeds in the simple mode.

At Step S2, the RSS feed information management unit 51 judges whether the list of RSS feeds is designated by the user to be displayed in the detail mode or not, and enter stands-by mode until it is judged that the user designated.

At Step S2 when it is judged at Step S2 that the list of RSS feeds is designated by the user to display in the detail mode, then at Step S3 the format converter unit 52 adjusts the RSS feeds format in accordance with the information supplied from the RSS feed information management unit 51, and outputs the information on the adjusted RSS feeds, to the display control unit 53. If it is designated to display a list of RSS feeds in the detail mode, information on the RSS feeds to be displayed in detail is supplied from the RSS feed information management unit 51 to the format converter unit 52.

In accordance with the information generated by the format converter unit 52, at Step S4 the display control unit 53 displays the title of a predetermined number of rows, picture of a predetermined size and main text of a predetermined number of rows of each RSS feed in the RSS feed display unit area 12 in the RSS feed list. In this manner, a list of RSS feeds having a good appearance and allowing easy viewed for a user is displayed, as shown in FIG. 3.

In the above description, in a list of RSS feeds displayed in the detail mode, only one picture is displayed for each RSS feed. However, if the RSS feed contains a plurality of pictures, pictures converted into a predetermined size may be displayed in a juxtaposed layout.

Also in the above description, a picture having vertical pixels larger than the predetermined number of vertical pixels is reduced and displayed. However, if the RSS feed contains a picture having vertical pixels less than the predetermined number of vertical pixels, the picture may be enlarged on a basis of the number of vertical pixels, to display an enlarged picture. In this manner, the picture having the same size can be displayed for all RSS feeds.

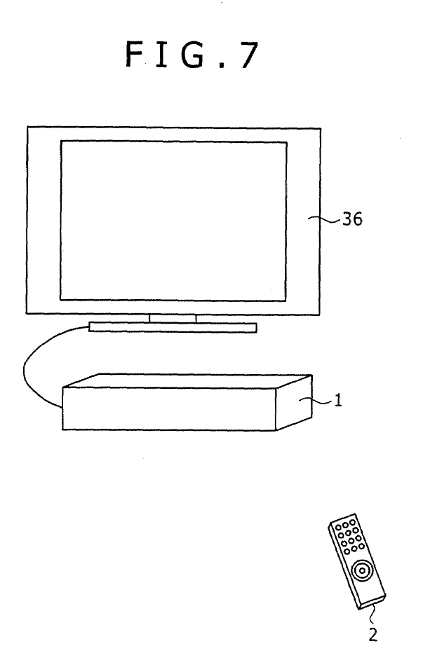

In the above description, the information processing apparatus 1 has the same configuration as that of a general television receiver. However, as shown in FIG. 7, the information processing apparatus 1 may be realized as an apparatus having a casing different from that of a television receiver.

In the example shown in FIG. 7, a display 36 is connected to the information processing apparatus 1 with a cable in between. A display on the display 36 is controlled by the information processing apparatus 1 in the manner described above.

Although an above-described series of processes may be possible by hardware and software. If a series of processes is performed by software, the program constituting the software is installed from a program recording medium into a computer assembled in dedicated hardware or into a computer such as a personal computer of general use capable of executing various functions by installing various programs.

The program executed by a computer (CPU 31) is provided by storing it in a removal medium 44 of an optical disc, or via wired or wireless transmission media, such as a local area network, the Internet and digital satellite broadcasting.

The program can be installed in the hard disk 38 via the input/output interface 35 by placing the removable medium 44 on the drive 43. The program may be received at the communication unit 39 via wired or wireless transmission media and installed in the hard disc 38. Further, the program may be installed in advance in ROM 32 or the hard disc 38.

The program to be executed by the computer may be a program executing a process sequentially in the order described in this specification, or a program executing processes in parallel or at necessary timings, such as when read out.

The embodiments of the present invention are not limited to those described above, but various modifications are possible without departing from the gist of the present invention.

According to the present invention, it is possible to display a list of feeds in the RSS format such that it is easy to view for a user.

It should be understood by those skilled in the art that various modifications, combinations, sub-combinations and alterations may occur depending on design requirements and other factors insofar as they are within the scope of the appended claims or the equivalents thereof.

The present document contains subject matter related to Japanese Patent Application No. 2007-000346 filed in the Japanese Patent Office on Jan. 5, 2007, the entire content of which being incorporated herein by reference.

What is claimed is:

1. An information processing apparatus comprising:
recording means for recording information on a feed of an RSS format;
converting means for converting a picture contained in each feed whose information is recorded in the recording means into a picture having a predetermined size on a basis of the number of vertical pixels; and
display controlling means for displaying, for each feed, a title and a main text by predetermined numbers of rows, and a picture obtained through conversion by the converting means at a predetermined position, if a predetermined operation is performed in a state where a list of feed titles is displayed.

2. The information processing apparatus according to claim 1, wherein:
the display control means displays for each feed one picture obtained through conversion by the converting means.

3. The information processing apparatus according to claim 1, wherein:
the converting means converts one picture designated to be displayed at a top, out of pictures contained in each feed.

4. The information processing apparatus according to claim 1, wherein:
the converting means reduces a size of an image having vertical pixels larger than a predetermined number of pixels to an image whose vertical pixel numbers are same with the predetermined number of pixels, the image being contained in each feed.

5. A display control method for an information processing apparatus having recording means for recording information on a feed of an RSS format, comprising steps of:
converting a picture contained in each feed whose information is recorded in the recording means into a picture having a predetermined size on the basis of the number of vertical pixels; and
displaying, for each feed, a title and a main text by predetermined numbers of rows, and a picture obtained by conversion at a predetermined position, when a predetermined operation is performed in a state that a list of feed titles is displayed.

6. A program for causing a computer to execute a process of an information processing apparatus having recording means for recording information on a feed of an RSS format, comprising steps of:
converting a picture contained in each feed whose information is recorded in the recording means into a picture having a predetermined size on the basis of the number of vertical pixels; and
displaying, for each feed, a title and a main text by predetermined numbers of rows, and a picture obtained through conversion at a predetermined position, when a predetermined operation is performed in a state that a list of feed titles is displayed.

7. An information processing apparatus comprising:
a recording section to record information on a feed of an RSS format;
a converting section where a picture contained in each feed whose information is recorded in the recording means is converted into a picture having a predetermined size on a basis of the number of vertical pixels; and
a display controlling section to display, for each feed, a title and a main text by predetermined numbers of rows, and a picture obtained through conversion by the converting means at a predetermined position, when a predetermined operation is performed in a state where a list of feed titles is displayed.
